(19) United States
(12) Patent Application Publication
(10) Pub. No.: US 2017/0337522 A1
(43) Pub. Date: Nov. 23, 2017

(54) METHODS AND SYSTEMS TO MANAGE GEOGRAPHICALLY TAGGED SERVICEABLE ASSETS

(71) Applicant: Ecotrak Facility Management, Inc, Anaheim, CA (US)

(72) Inventor: David Bennett, Anaheim, CA (US)

(21) Appl. No.: 15/158,493

(22) Filed: May 18, 2016

(51) Int. Cl. G06Q 10/10; G06Q 10/00; G06F 21/31; H04W 4/02; G06F 17/30

(52) U.S. Cl. CPC G06Q 10/1097; H04W 4/025; G06F 17/30241; G06F 21/31; G06Q 10/20

(57) ABSTRACT

Using various embodiments, methods and systems for managing geographically tagged serviceable assets are described. In one embodiment, a system is configured to granted access to a user, receive asset data that includes geographical information of the asset, and associate the asset data with a service provider associated with the user. The system can further be configured to receive an asset retrieval request from the user, determine assets within a predetermined distance from the user, and transmit related asset data to the user. In one embodiment, the system can also receive a service request from a requestor or client to service an asset, identify the service provider, and generate a work order based on the service request for the service provider. In another embodiment, the system can also notify the service provider about the work order, and transmit a confirmation message to the requestor about the generated work order.

### FIELD OF THE INVENTION

Embodiments of the present invention relates generally to serviceable asset management. More particularly, embodiments of the invention relate to cataloging, tracking, and generating work orders for geographically tagged serviceable assets.

### BACKGROUND OF THE INVENTION

Traditionally, management of fixed/non-movable serviceable assets includes manually entering make, model, and serial number from invoices or a technician's log in to a computing system. Further, generating work orders for a client/requestor involves manually entering data after receiving instructions from the requestor, either by phone or in person.

Although management of assets can be performed by manually entering make, model, serial number of an asset into a computer system, and further can be retrieved by associating scannable bar codes on to the asset, such systems have an implied presumption that the service provider would have access to a bar code scanner to retrieve information about the asset. Furthermore, management by scanning bar codes is limited to retrieving information related to an asset only after the technician of the service provider is physically present at the client/requestor's location. Another limitation of existing serviceable asset management systems is that, in case of servicing an asset, tracking the location of the asset has to be performed manually by the service provider technician.

Therefore, what is needed are techniques, methods, and systems to better manage fixed/non-movable serviceable assets without the need of bar code scanners. Further, such techniques, methods, and systems should be able to provide a mechanism to track and monitor the serviceable asset throughout the life cycle of the serviceable asset.

### SUMMARY OF THE DESCRIPTION

Using various embodiments, systems, methods, and devices to manage serviceable assets are described herein. In one embodiment, a system implementing the techniques described herein comprises an authentication subsystem configured to determine permissions granted to a user. The user can be associated with an asset service provider or with a client/customer. Access to the system for each user can be limited based on their roles and responsibilities and can be set up by an administrator account by the service provider and/or the customer. The system can further comprise an asset processing subsystem that can be configured to receive serviceable asset data including at least a latitude and longitude of the location where a serviceable asset is located, and associate the serviceable asset data with service provider identification data associated with the user. The system can further include an asset retrieval subsystem that can receive an asset retrieval request, including the current latitude and longitude of the user, to retrieve serviceable asset data, determine assets within a predetermined distance from the user, and transmit serviceable asset data of the determined assets to the user. In one embodiment, the system can further include an asset service requestor subsystem to receive a service request from a requestor to service the serviceable asset, the service request comprising identification information of the serviceable asset, identify the service provider associated with the serviceable asset, and generate a work order based on the service request for the service provider of the serviceable asset. In another embodiment, the system can include a notification subsystem to notify the service provider about the work order, and transmit a message to the requestor confirming the generation of the work order.

In yet another embodiment, the serviceable asset can be non-movable and can be at least one of a machinery or fixture, and wherein the work order relates to a request to at least clean or repair the serviceable asset. In one embodiment, the serviceable asset can be a heating, ventilating, and air conditioning (HVAC) equipment, cooking equipment, refrigeration equipment, cooling tower, lighting equipment, or any other non-moveable/fixed machine or fixture. The serviceable asset data can, in another embodiment, further include asset type information, an image, a model identifier, and a serial number associated with the serviceable asset.

In one embodiment, a notification subsystem of the system described herein notifies the service provider of the service request by an electronic mail (e-mail), a short messaging service (SMS), a notification indicator, a pop-up window, or any other technique known to a person having ordinary skill in the art. The system can, in another embodiment, further be configured to provide the user an asset service history that provides the user with total repair costs, work orders, problems, failures, and resolutions for the serviceable asset based on past service requests of the serviceable asset. In one embodiment, the service request can include one or more images provided by the requestor, where the images are associated with a problem or issue related to the serviceable asset.

### BRIEF DESCRIPTION OF THE DRAWINGS

The present invention is illustrated by way of example and not limitation in the figures of the accompanying drawings in which like references indicate similar elements.

FIG. 1 illustrates a block diagram of a system according to one embodiment of the present invention.

FIG. 2 illustrates a flow chart of a server, implementing the techniques described herein, transmitting an asset list to a client device, according to one embodiment of the present invention.

FIG. 3 illustrates a flow chart of a client device, implementing the techniques described herein, receiving an asset list from a server, according to one embodiment of the present invention.

FIG. 4 illustrates a flow chart of a server receiving serviceable asset data to catalog, according to one embodiment of the present invention.

FIG. 5 illustrates a flow chart of a client device transmitting serviceable asset data to catalog by the server, according to one embodiment of the present invention.

FIG. 6 illustrates a flow chart of a server receiving a service request to generate a work order and transmit a notification to a service provider, according to one embodiment of the present invention.

FIG. 7 illustrates a flow chart of a client device transmitting a service request to generate a work order for a service provider, according to one embodiment of the present invention.

FIG. 8 illustrates user interface to catalog an asset, according to one embodiment of the present invention.

FIG. 9 illustrates user interface to locate assets related to a service provider or customer according to one embodiment of the present invention.

FIG. 10 illustrates user interface of displaying an asset list related to a service provider, according to one embodiment of the present invention.

FIG. 11 illustrates user interface displaying asset data related to a service provider, according to one embodiment of the present invention.

FIG. 12 illustrates user interface displaying asset history of an asset, according to one embodiment of the present invention.

FIG. 13 illustrates user interface to request generation of a work order by the server related to an asset, by a service request, according to one embodiment of the present invention.

FIG. 14 is a block diagram illustrating a data processing system such as a server or client device that can be used with one embodiment of the invention.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” or “another embodiment” means that a particular feature, structure, or characteristic described in conjunction with the embodiment can be included in at least one embodiment of the invention. The appearances of the phrase “in one embodiment” in various places in the specification do not necessarily all refer to the same embodiment. The processes depicted in the figures that follow are performed by processing logic that comprises hardware (e.g., circuitry, dedicated logic, etc.), software, or a combination of both. Although the processes are described below in terms of some sequential operations, it should be appreciated that some of the operations described can be performed in a different order. Moreover, some operations can be performed in parallel rather than sequentially.

Using various embodiments, a systems and methods to manage serviceable assets are described. In one embodiment, a system can utilize geographical location data derived from global positioning system (GPS) (based on latitude, longitude, and/or altitude-coordinates) to pinpoint a specific serviceable asset within a predetermined radius and/or distance from a user/technician of a service provider (e.g., 10 feet, 15 feet, 20 feet, etc.). A service provider is a company or person that provides an organization (client/requestor) with repair services on a specified asset type at a specific location. As described herein, the term “asset” and “serviceable asset” have been used interchangeably. An asset or serviceable asset, as described herein, is any equipment that can be installed in (or on) a building and requires regular maintenance (that is, the equipment may need to be repaired, cleaned, replace parts, etc. at various durations). As a non-limiting example, an asset can be a heating, ventilation, and air conditioning (HVAC) unit, air-conditioning unit, heating unit, cooking equipment, water dispensing unit, refrigeration unit, cooling tower, lighting fixtures, or other ‘furniture, fixtures, or other equipment’ (FF&E), etc. The system can further be configured to accept one or more images, log one or more latitude/longitude/altitude-coordinates (geo-tags), make, model, serial number, description, and condition of the serviceable asset while cataloging the asset information. Generally, a “geo-tag,” or “geotag” as described herein, is geospatial metadata and “geo-tagging an asset” refers to the process of adding geographical identification metadata to various media related to a serviceable asset, such as a photograph or video, website, Short Messaging Service (SMS) messages, Quick Response (QR) Codes, or Rich Site Summary (RSS, also known as Really Simple Syndication) feeds. In one embodiment, geo-tagged data can also comprise latitude and longitude coordinates altitude, bearing, distance, accuracy data, place names, or a combination thereof. Once the asset data is provided to a server of the system, preferably by a user/technician of the service provider, a system implementing the techniques described herein can further catalog this information to a remote server (e.g., via WiFi, Local Area Network (LAN), cellular connection, Bluetooth, etc.) and associate the serviceable asset to the service provider. The cataloged asset data can then be retrieved by the user or technician, having with the appropriate permissions. The techniques discussed herein can be, in one embodiment, used by organizations that have fixed serviceable assets that are in need of continual planned maintenance, emergency service repairs, replacement, retirement/disposal, or a combination thereof. By geo-tagging fixed serviceable assets, an organization can be capable of tracking and monitoring the life cycle and total cost of ownership of their valuable, profit generating fixed serviceable assets.

In one embodiment, a permitted user of the service provider can log into the system and retrieve a list of all the assets for the location (related to the service provider and/or customer) upon sign-in based on the user's geographical location. In another embodiment, the asset list for the location can be further filtered by the user (e.g., by selecting a ‘Find Asset’ search icon or button). In one embodiment, all cataloged assets can filter to within a predetermined distance of the user's current physical location. Upon selection of a desired asset, the user can retrieve service history, edit, or place a service request for the asset.

In one embodiment, each serviceable asset can have multiple-zone geo-tags depending on the configuration of the serviceable asset. For example, for an HVAC unit, a geo-tag can be captured of the physical location of the asset in/on a building (e.g., on the roof), a geo-tag can be captured of the location of the thermostat that operates the HVAC unit, a geo-tag can be captured of the area of the building the HVAC unit serves, or a combination thereof. Further, each serviceable asset can further be cataloged by Asset Type (e.g., a HVAC unit), a common description (e.g. “South Dining AC Unit”), or a combination thereof. Further, any asset can be located within the predetermined distance or radius from the user, and a list of assets within that radius is viewable and available to the user for selection. An authenticated user can further update a serviceable asset's information in real-time. In one embodiment, the system can be configured to provide the user a “Find My Location” functionality that can identify the physical address of the user's current location, and provide a complete list of the assets therein. In one embodiment, only assets related to the service provider of the user are displayed. Further, a “Find Asset” functionality can narrow the field of search for any assets residing in the predetermined distance from the user. In another embodiment, the user is also provided with images of each asset for ease of identification and selection.

In another embodiment, the system can provide a serviceable asset history (e.g., repairs, maintenance, etc.) to the service provider user and/or customer user. The serviceable asset history can be configured to be viewable only to a number of users defined based on their permission level. For example, in one embodiment, the history of the serviceable assets can only be displayed to users who are technicians of the service provider. In another embodiment, each user, based on their permission level, can view different aspects of the serviceable asset history. For example, an accountant is limited in seeing the financial aspects (e.g., cost of service, dates of service, etc.) of the serviceable asset, and a technician is limited in seeing the serviceable aspects (e.g., type of service, date of service, etc.) of the serviceable asset.

In another embodiment, a system implementing the techniques described herein provides instant physical condition and/or warranty statuses associated with the serviceable asset to a user of the service provider. In yet another embodiment, a client/customer/requestor can place a service request in the event a serviceable asset is in not functioning properly (or needs maintenance).

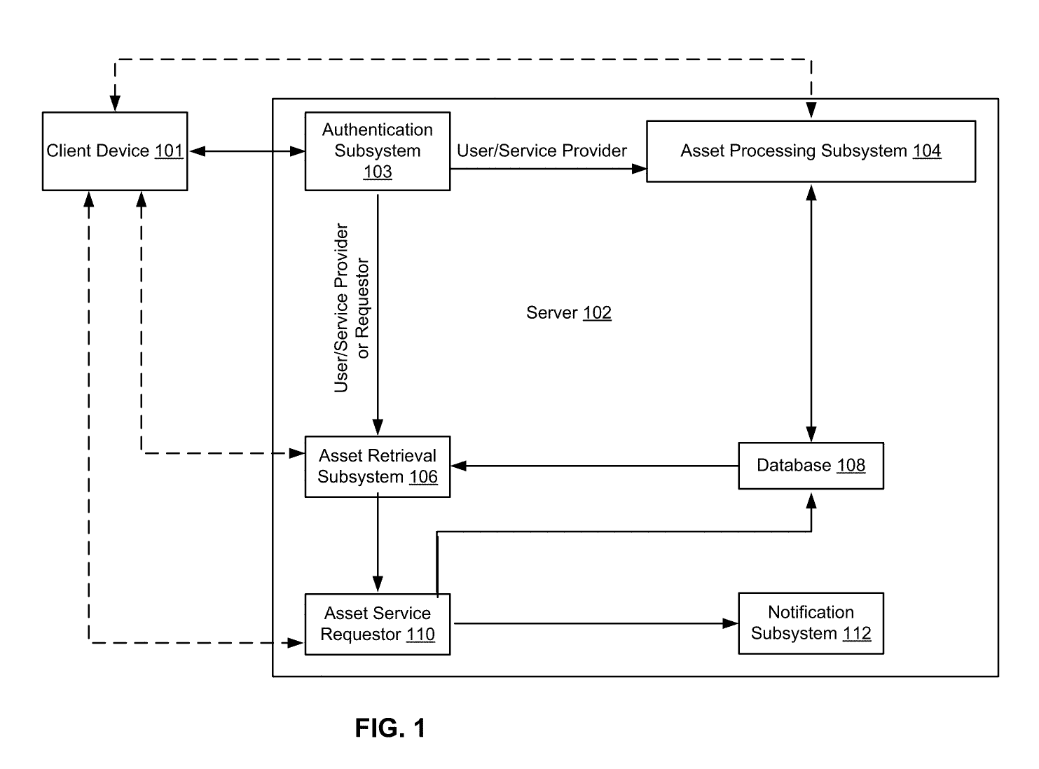

FIG. 1 illustrates a block diagram of a system according to one embodiment of the present invention. As illustrated, a system implementing the techniques discussed herein can include client device 101 and server 102. In one embodiment, server 102 can comprise an authentication subsystem 103. Authentication subsystem 103 can grant access to authorized users of the system and determines each user's access level. Server 102 can also comprise asset processing subsystem 104 to process and catalog assets into database 108. In one embodiment, asset processing subsystem 104 can further associate asset data (serviceable asset data) with service providers and clients of the service provider. Asset data, in one embodiment, can include image(s), latitude/longitude/altitude-coordinates (geo-tags), make, model, serial number, description, or condition of the serviceable asset. In another embodiment, asset data can also include multiple geo-tag data, as described herein. In one embodiment, geo-tagged data can also comprise latitude and longitude coordinates altitude, bearing, distance, accuracy data, place names, or a combination thereof. Once the asset data is provided to server 102, preferably by a user/technician of the service provider, server 102 can catalog this information and associate the serviceable asset to the service provider. Cataloging refers to creating an initial inventory of a serviceable assets and gathering the data including at least one of photos of equipment, geo-tags, asset type, area, description, manufacturer, model Number, serial Number, condition of Serviceable Asset, notes, etc. The cataloged asset data can then be retrieved by any user or technician, having with the appropriate permissions.

Server 102 can also comprise asset retrieval subsystem 106 that can retrieve assets associated with a service provider or customer. In one embodiment, only assets within a pre-determined distance or radius from the user (or client) are retrieved by asset retrieval subsystem 106 from database 108. In one embodiment, the system can utilize geographical location data derived from GPS based on latitude/longitude/altitude-coordinates to pinpoint a specific serviceable asset within a predetermined radius/distances from a user/technician of a service provider (e.g., 10 feet, 15 feet, 20 feet, etc.). In one embodiment, to determine the planer distance of an asset from the user, the distance between the user and the asset can be computed by the following trigonometric equation:

distance_{Horizontal}=a cos((sin(φ1×Π/180)×sin(φ2×Π/180)+cos(φ1×Π/180)×cos(φ2×Π/180)×cos((λ1−λ2)×Π/180))×Π/180

where φ1 is the latitude of user's current location in radians, φ2 is the latitude of the asset's location stored in database, in radians, λ1 is the longitude of user's current location in radians, and λ2 is the longitude of the asset's location, in radians, stored in database. In the above equation, distance_{Horizontal} is a distance per degree. Therefore, in order to determine the distance between the user and the assets in feet, the equation can be multiplied by the number of nautical miles in a degree of latitude (60) multiplied by the number of statute miles in a nautical mile (1.1515) and further multiplied by the number of feet in a mile (5280). One the distance between a given asset and the user is determined, if the distance is between the predetermined distance from the user, the asset is displayed in the asset list.

In another embodiment, asset retrieval subsystem 106 can also determine assets within a predetermined distance vertical distance from the user. In order to determine the vertical height of an asset relative to a user, the vertical distance can be calculated by:

distance_{Vertical}=((Aᵤₛₑᵣ−Aₐₛₛₑₜ)+(Vᵤₛₑᵣ−Vₐₛₛₑₜ))

where Aᵤₛₑᵣ is the altitude and Vᵤₛₑᵣ is vertical accuracy of user's current location, Aₐₛₛₑₜ is the altitude and Vₐₛₛₑₜ is the vertical accuracy stored in database for asset's location. If an asset is found to be within the predetermined distance from the user, it is displayed in the asset list.

In yet another embodiment, after determining distance_{Horizontal} and distance_{Vertical} of each asset of a customer, the shortest distance between the asset and the user can be approximated by:

\sqrt{(distance_{Vertical})²+(distance_{Horizontal})²}

Thus, in this embodiment, any assets having a shortest distance within the predetermined distance would be listed in the user's asset list.

The system can further include an asset service requestor subsystem 110 that can assist a technician or client issue a service request, that is, a request to service an asset. After a successful service request has been placed, Asset service requestor subsystem 110 can further generate work orders and issue an instruction to notification subsystem 112 to notify the service provider and/or client of the generated work order associated with the service request. In one embodiment, notification subsystem 112 notifies the service provider about the generated work order via simple short messaging (SMS), electronic mail, a popup window, or a notification icon when the service provider logs into the system. In one embodiment, a work order can include enough information so that the service provider can ascertain the serviceable asset for which the work order was generated and the associated request provided in the service request. In one embodiment, the service request can also include one or more images depicting a problem or issue with the asset. In this embodiment, asset service requestor subsystem can provide such images to the service provider in the associated work order.

Authentication subsystem 103 can also determine the subsystems a user/client can access. For example, in one embodiment, a requestor (client of a service provider), after being authenticated by authentication subsystem 103, can only be given access to interact with the asset retrieval subsystem 106 to retrieve the requestor's assets and can further be permitted to request service via asset service requestor 110. Similarly, a user related to a service provider can be granted access to asset retrieval subsystem 106 to retrieve assets associated with the service provider, asset service requestor 110 to generate service requests on the client's behalf as well as asset processing subsystem 104 to catalog assets in database 108. It should be noted, throughout this document, database 108 refers to a logical database and can be a relational database, a non-relational database, or a combination thereof.

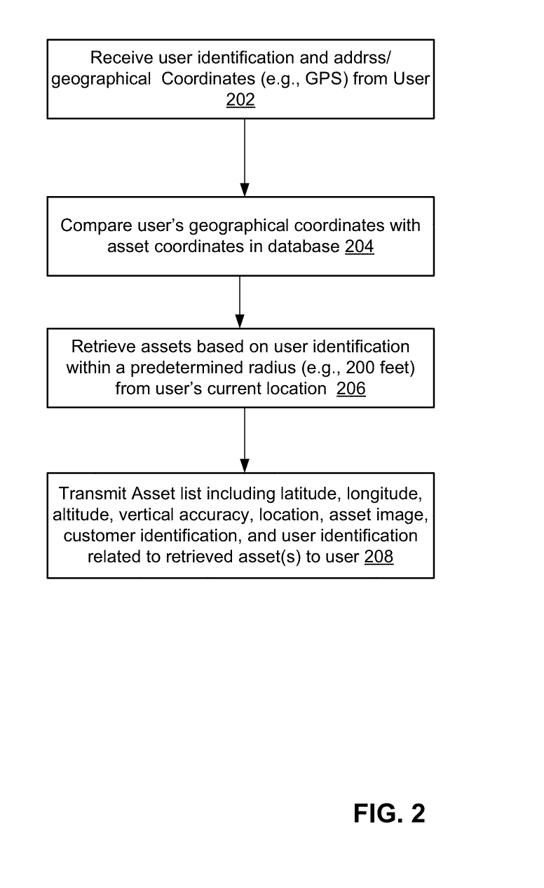

FIG. 2 illustrates a flow chart of a server, implementing the techniques described herein, transmitting an asset list to a client device, according to one embodiment of the present invention. As illustrated, at 202, in one embodiment, asset retrieval subsystem 106 can receive user identification associated with a service provider along with the location around which the assets need to be retrieved. Users can either provide their location by transmitting the GPS coordinates of their current location or by typing an address/landmark. If the location is provided by providing an address, the system is able to retrieve the geographical coordinates of the provided address or landmark. At 204, the geographical coordinates provided by the user are compared with the coordinates of the assets in database 108. At 206, the assets are retrieved based on user identification within a predetermined radius from the user's current location. User identification can be a client's identification information or a technician/user associated with a service provider. In one embodiment, the pre-determined radius or distance can be different based on the type of user. For example, if the user is a client interested in viewing the assets associated with their account, in one embodiment, the predetermined distance for the client user can be set to a variable number (enough to cover a city, state, country, etc.) from the user, so that all assets associated with the client can be displayed to that user. Similarly, if the user is a technician, the predetermined distance can be set to a smaller distance (e.g., 15 feet, 50 feet, etc.), so that only assets that are within the technician's immediate location can be retrieved by asset retrieval subsystem 106. At 208, once the assets within the predetermined distance from the user have been retrieved, an asset list with corresponding asset data can be generated and transmitted to the user. In one embodiment, assets only related to a particular customer are displayed to the service provider user or the customer user.

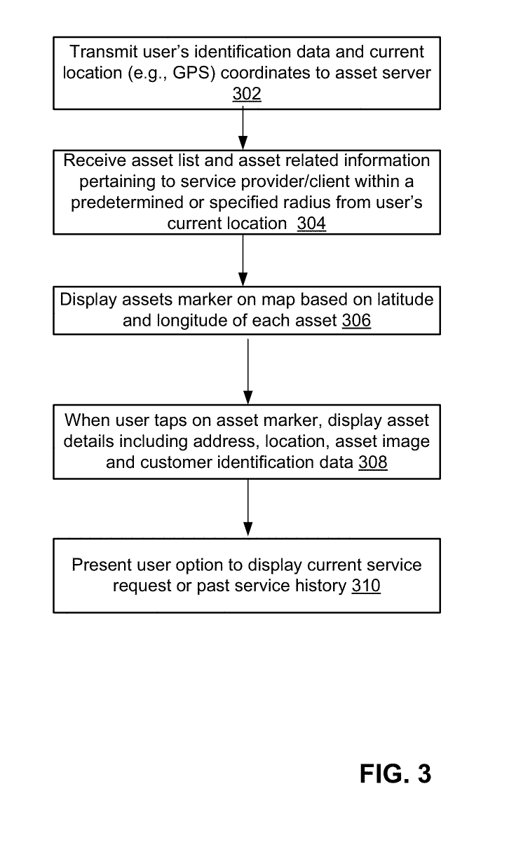

FIG. 3 illustrates a flow chart of a client device, implementing the techniques described herein, receiving an asset list from a server, according to one embodiment of the present invention. At 302, the client device transmits the user identification data and location from where the assets need to be retrieved. At 304, the asset list including associated asset information related to the user within a predetermined distance is received. At 306, the user is displayed a map displaying the retrieved asset location as markers (on the map). At 308, when the user taps on an asset marker, the asset details are displayed to the user. At 310, the user is presented the option to display current service request, place a new service request or view past service history associated with the asset.

In an alternative embodiment, at 306, instead of a map displaying the associated assets as asset markers the assets are retrieved and displayed as a list. In this embodiment, once the user clicks or taps on an asset from the list, control passes to 308 where the asset details are displayed to the user.

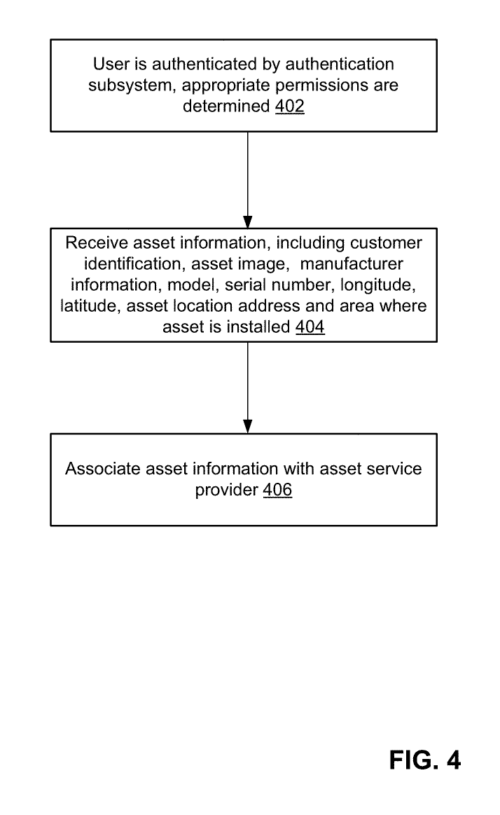

FIG. 4 illustrates a flow chart of a server receiving serviceable asset data to catalog, according to one embodiment of the present invention. At 402, a user of the service provider is authenticated and appropriate permissions are determined to access asset processing subsystem 104. At 404, the asset processing subsystem 104 received asset information including customer/client identification information, an asset image, manufacturer information, model, serial number, longitude, latitude, vertical altitude, asset location (address), area within the location where the asset is located, or a combination thereof. At 406, asset processing subsystem 104 associates the received asset information with the asset service provider.

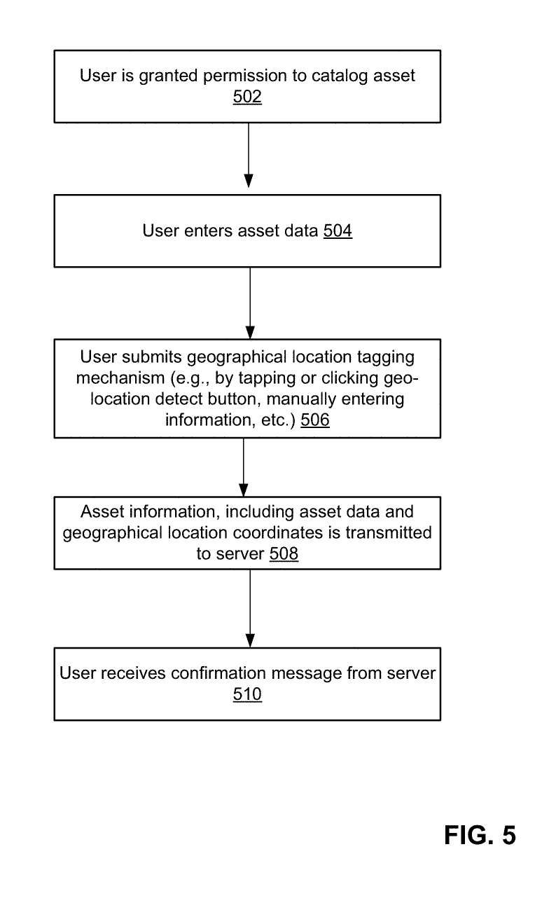

FIG. 5 illustrates a flow chart of a client device transmitting serviceable asset data to catalog by the server, according to one embodiment of the present invention. At 502, the user associated with a service provider is granted permission to catalog an asset. At 504, the user enters asset data as described herein. At 506, the user submits geographical location data to geo-tag the asset. At 508, the asset information, including asset data and geographical location coordinates are transmitted to the server. At 510, the user receives a confirmation message that the asset has been successfully cataloged.

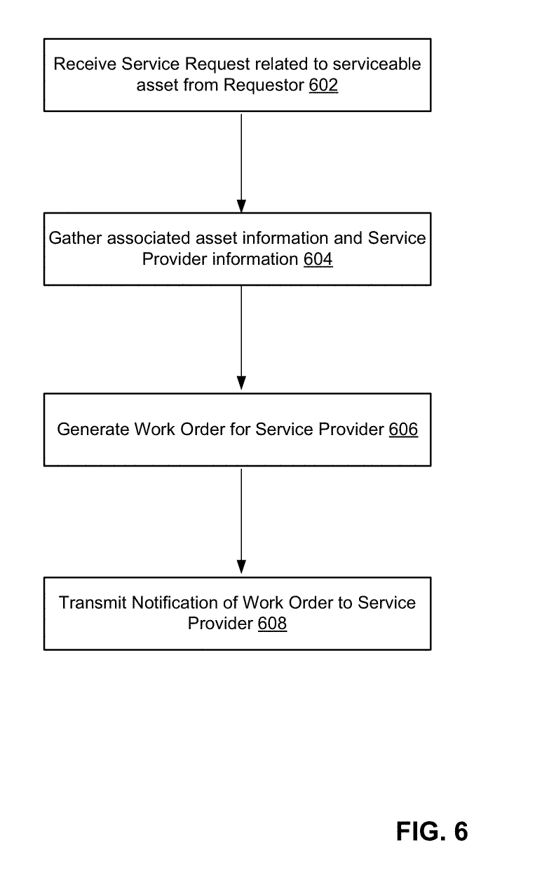

FIG. 6 illustrates a flow chart of a server receiving a service request to generate a work order and transmit a notification to a service provider, according to one embodiment of the present invention. At 602, after a user selects an asset, the asset service requestor 110 receives a service request related to an asset from a requestor. In one embodiment, the requestor can be a client of the service provider. In another embodiment, the requestor can be a technician of the service provider acting on behalf of the client. At 604, asset service requestor subsystem 110 gathers associated asset information and service provider information from database 108. At 608, asset service requestor generates a work order for the service provider based on the information provided in the service request received at 602 and the information gathered at 604. At 608, asset service requestor subsystem 110 instructs notification subsystem 112 to transmit a notification to the service provider about the work order. Optionally, a notification can also be sent to the client/requestor about the generated work order based on the service request.

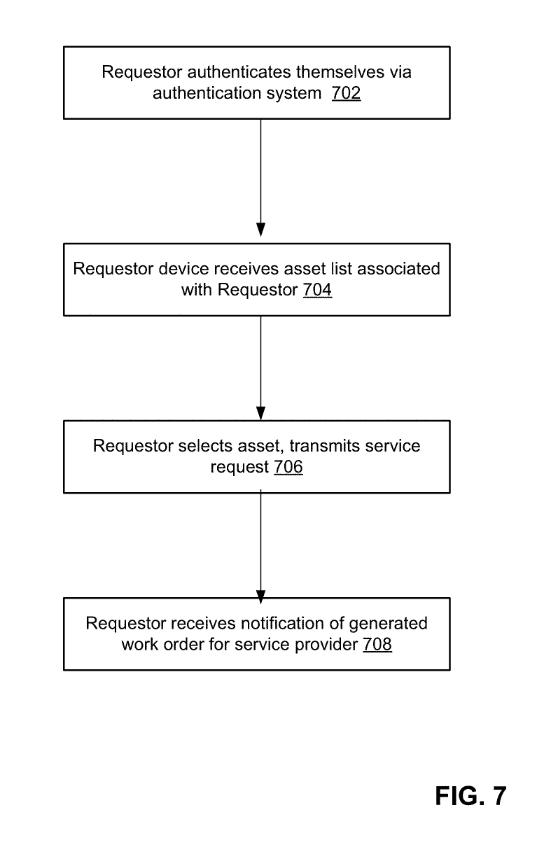

FIG. 7 illustrates a flow chart of a client device transmitting a service request to generate a work order for a service provider, according to one embodiment of the present invention. At 702, the requestor is authenticated by authentication subsystem 103. At 704, the requestor device receives asset list associated with the requestor. At 706, the requestor selects an asset and generates a service request. At 710, the requestor receives a notification about the generated work order.

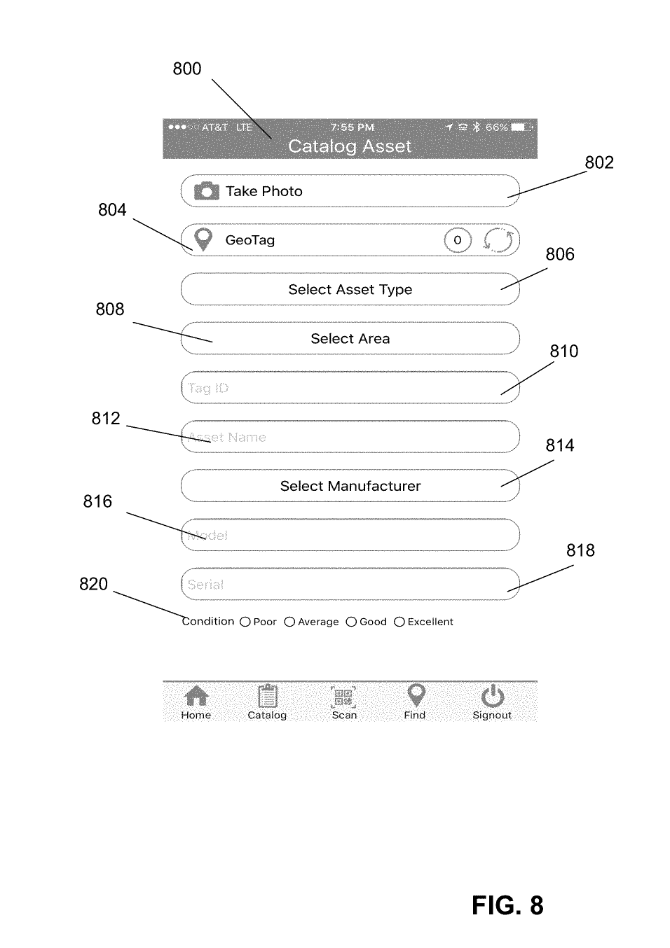

FIG. 8 illustrates user interface 800 to catalog an asset, according to one embodiment of the present invention. As illustrated a user/technician of a service provider, using a mobile device (e.g., Smartphone, tablet, etc.), can catalog an asset by providing asset information as described herein. The user can, at field 802 associate photographs/images of the asset being cataloged. At field 804, the user can request a geo-tag associated with the user's current location be determined. In one embodiment, the asset can have multiple-zone geo-tags depending on the configuration of the serviceable asset. For example, for a HVAC unit, a geo-tag can be captured of the physical location of the asset in/on a building (e.g., on the roof), a geo-tag can be captured of the location of the thermostat that operates the HVAC unit, a geo-tag can be captured of the area of the building the HVAC unit serves, or a combination thereof. In one embodiment, non-movable serviceable assets are geo-tagged multiple times during the cataloging process. The geo-tags are not limited only the area the serviceable asset resides, but can also be associated with areas at which the serviceable asset is utilized. For example, a Roof Top Air Conditioner (RTU) can have a fixed location on the roof of a building, but can control the temperature of a section (zone) of a building. Thus, a user can geo-tag a few spots where the RTU resides, and a few locations of the section/zone of the building where the RTU controls the temperature. This solution can resolve a long standing issue where the service provider repairs or services the incorrect RTU for a particular zone.

In another embodiment, the system can be configured to provide the user an asset grouping mechanism based on type or functionality of the asset. This can be configured by providing field 806 where the user is provided a list of asset types from which the user can select the type of the asset being cataloged. For example, an asset type group can include asset type ‘Refrigeration’ that can include walk-in coolers, ice machines, reach-in coolers, water-coolers, etc. and asset type ‘Cooking Equipment’ can include assets such as a fryer, oven, boiler, etc. Similarly asset type ‘Environmental Control Systems’ can include assets such as a HVAC unit, an air-conditioning unit, heating system, ventilation system, etc. In one embodiment, field 810 can be provided to submit a tag id associated with the asset. At field 812, asset name can be provided. At field 814, the user can select a manufacturer of the unit. In one embodiment, the user is given a list of available manufacturers. In another embodiment, the user can edit the list of manufacturers and add a new manufacturer associated with the asset. At field 816 the user can specify the model and at 818 the user can provide a serial number associated with the asset. The user can state the condition of the asset at 820, as illustrated. An authenticated user (e.g., service technician) can further update an asset's information in real-time. As discussed above, the system, in one embodiment, can be configured to take one or more images, log one or more latitude/longitude/altitude-coordinates (geo-tags), make, model, serial number, description, and condition of the serviceable asset.

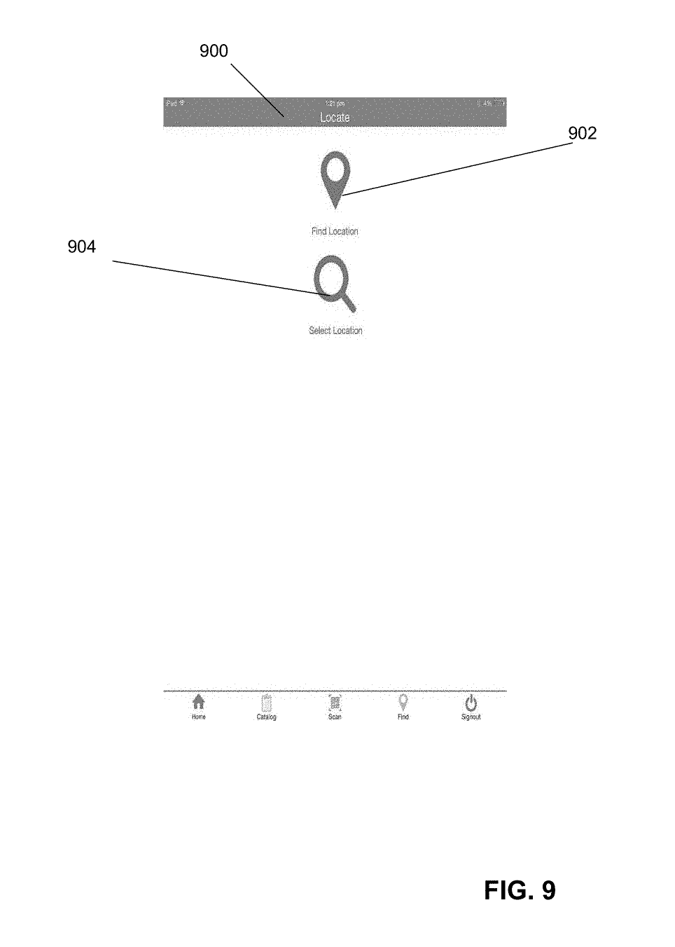

FIG. 9 illustrates user interface 900 to locate assets related to a service provider or customer, according to one embodiment of the present invention. In one embodiment, the system can be configured to provide the user a “Find My Location” functionality that can identify the physical address of the user's current location, and provide a complete list of the assets therein. In one embodiment, only assets related to the service provider of the user are displayed. As illustrated, to locate assets a service provide/user or client is given the option to find user's location 902 by using the mobile device's GPS unit, or by manually selecting a location, as illustrated by 904. In one embodiment, any asset associated with the user (requestor or service provider) can be located within the predetermined distance or radius from the user, and a list of assets within that radius is viewable and available to the user for selection. In one embodiment, the system can be configured to provide the user a “Find My Location” functionality that can identify the physical address of the user's current location, and provide a complete list of the assets therein. In one embodiment, only assets related to the service provider of the user are displayed. In one embodiment, clicking on the find location initiates a location services application program interface (API) call to a third party.

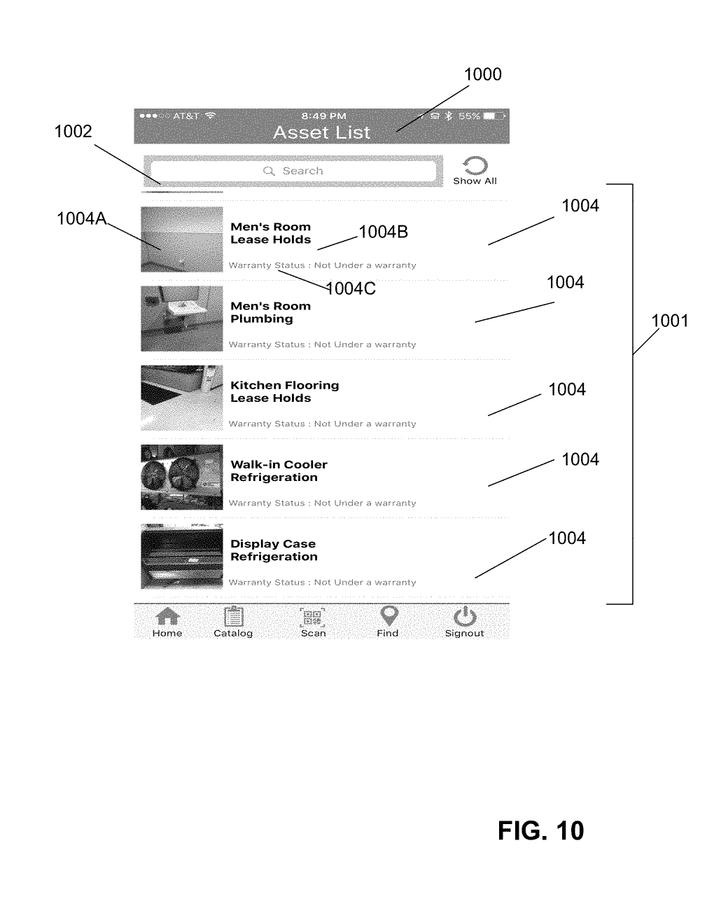

FIG. 10 illustrates user interface 1000 of displaying an asset list 1001 related to a service provider, according to one embodiment of the present invention. As illustrated, once a user provides a location by either letting the mobile device find the user's location 902 or by manually entering their address 904, an asset list 1001 within a predetermined distance or radius from the user can be determined and transmitted to the user. Each asset list 1001 can comprise of one or more assets 1004. In one embodiment, asset list 1001 can be further filtered by the user (e.g., by selecting a ‘Find Asset’ icon or button). In this embodiment, after the user clicks on the find asset icon or button, the system can be configured to provide the user search feature 1002 where the user can search for a given asset 1004 out of asset list 1001. For each asset 1004 in asset list 1001, the user can be provided identifying information about the asset. In one embodiment, identifying information about asset 1004 can include image 1004A, an asset identifier or name 1004B, current warranty status 1004C, or a combination thereof. In one embodiment, asset list 1001 can filter to within a predetermined distance of the user's current physical location.

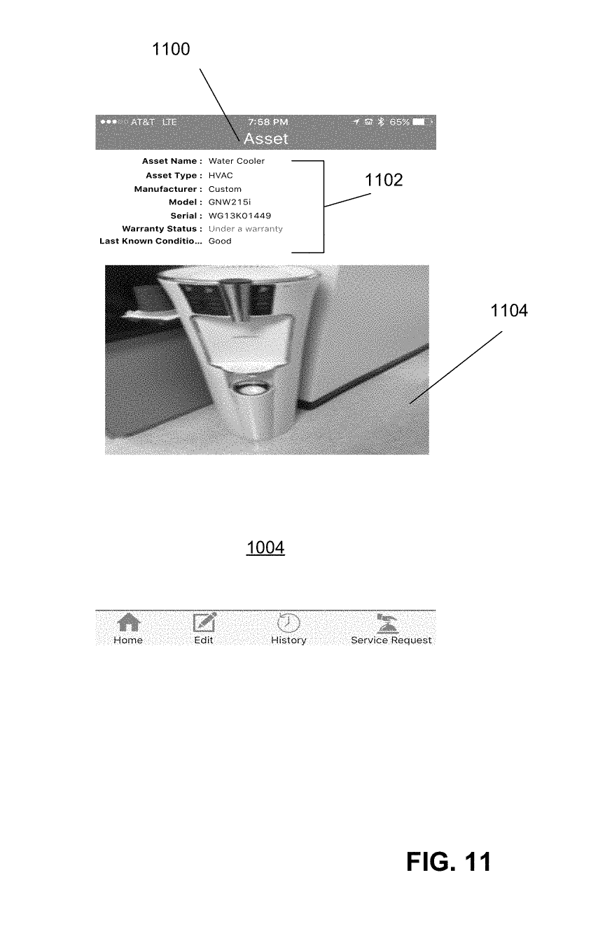

FIG. 11 illustrates user interface 1100 displaying asset data related to a service provider, according to one embodiment of the present invention. Upon selection of a desired asset, the user can retrieve service history, edit, or place a service request for the asset. Once a user clicks or taps over a row of asset 1004, user interface 1100 is displayed to the user. As illustrated, asset information 1102 can be displayed. In another embodiment, one or more images 1104 can also be displayed to the user to assist identifying the asset. In one embodiment, instant physical condition and warranty statuses associated with the asset 1004 are displayed to the user of the service provider.

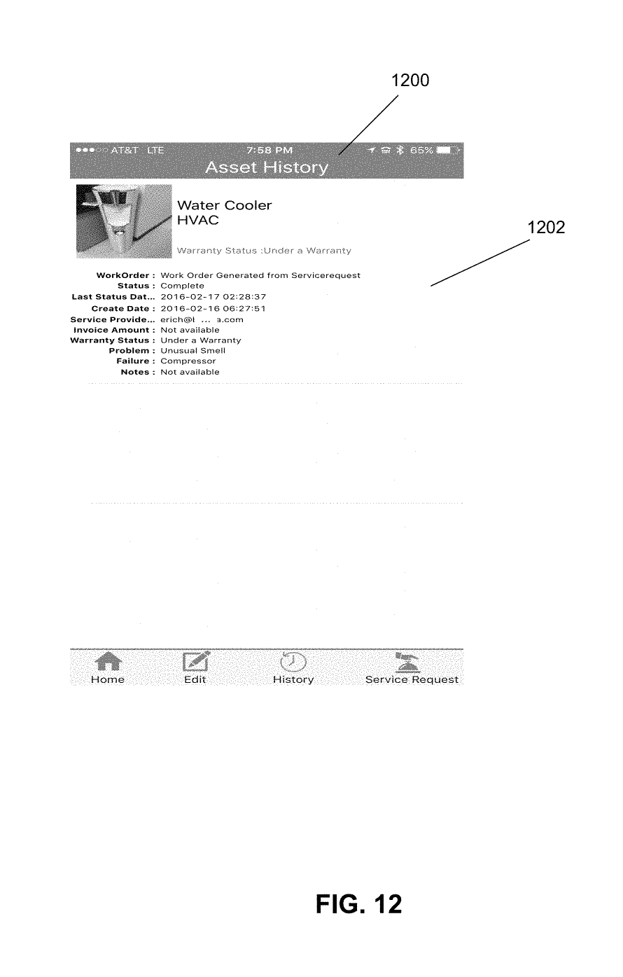

FIG. 12 illustrates user interface 1200 displaying asset service history of an asset, according to one embodiment of the present invention. In this embodiment, the system provides a serviceable asset history (e.g., repairs, maintenance, etc.) to the user. The serviceable asset history can be configured to be viewable only to a number of users defined based on their permission level. For example, in one embodiment, the history of the serviceable assets can only be displayed to users who are technicians of the service provider. In another embodiment, each user, based on their permission level, can view different aspects of the serviceable asset history. For example, an accountant is limited in seeing the financial aspects (e.g., cost of service, dates of service, etc.) of the serviceable asset, and a technician is limited in seeing the serviceable aspects (e.g., type of service, date of service, etc.) of the serviceable asset.

Thus, depending on the authentication level, the user is also given an option to view the asset service history, in one embodiment. As illustrated, the user can view asset history work order details 1202 that can include work order type, status, last status date, work order create date, service provider name, amount invoiced for work order, warranty status at time of the work order, the problem of the work order, whether if there was a failure of any associated part(s) of the asset, service technician notes, or a combination thereof.

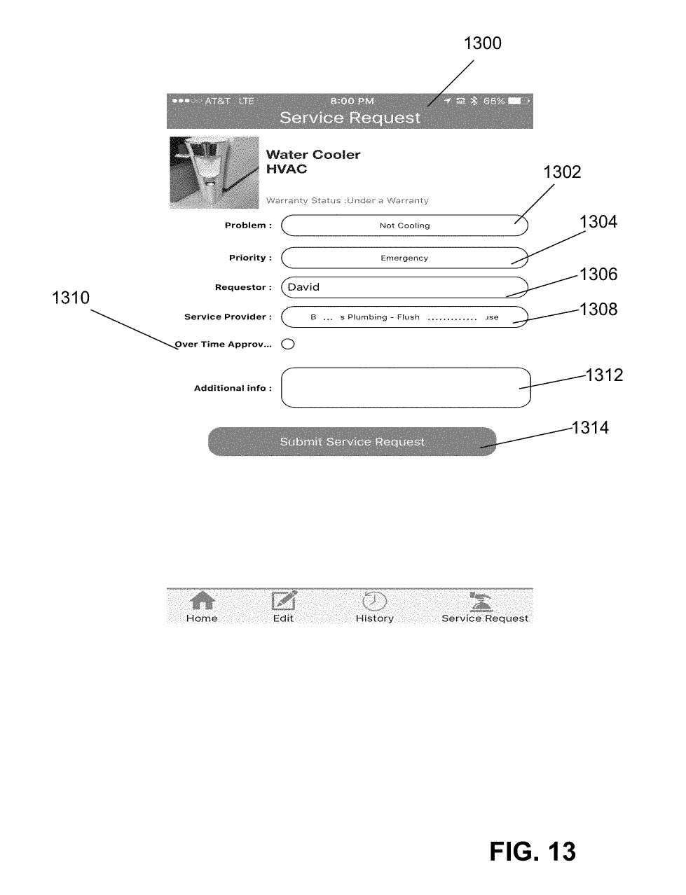

FIG. 13 illustrates user interface 1300 to request generation of a work order by the server related to an asset 1004, by a service request, according to one embodiment of the present invention. As illustrated, a work order can include field 1302 in which a user (client or service technician) can enter a problem related to the service request, field 1304 identifying the priority of the service request, field 1306 to identify the requestor/client of the service request, field 1308 identifying the service provider associated with the asset, field 1310 identifying whether overtime would be approved by the requestor, field 1312 for any additional notes, or a combination thereof. In another embodiment, the user is also given the opportunity to upload any images that would assist the service provider in identifying the problem for which the service request is being placed. Button 1314 can be provided to submit the service request to the system; the system can then generate a work order and notify the parties, as discussed herein.

In one embodiment, the service request field 1304 indicating priority of the service request signifies the amount of time a service provider is required to respond to a service request. Field 1302 (problem) can refer to as a pre-defined description of symptoms that are relevant to the asset (e.g., for a HVAC unit, a problem can be not cooling). In one embodiment, prior to servicing a work order, the service provider can transmit a proposal to the client/requestor. A proposal can be an estimate for the repair, cleaning, or replacement of the service asset.

The techniques shown in the figures can be implemented using computer program instructions (computer code) and data stored and executed on one or more electronic systems (e.g., computer systems, etc.). Such electronic systems store and communicate (internally and/or with other electronic systems over a network) code and data using machine-readable media, such as machine-readable non-transitory storage media (e.g., magnetic disks; optical disks; random access memory; dynamic random access memory; read only memory; flash memory devices; phase-change memory). In addition, such electronic systems typically include a set of one or more processors coupled to one or more other components, such as one or more storage devices, user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device.

It should be apparent from this description that aspects of the present invention may be embodied, at least in part, in software. That is, the techniques may be carried out in a computer system or other computer system in response to its processor, such as a microprocessor, executing sequences of instructions contained in memory, such as a ROM, DRAM, mass storage, or a remote storage device. In various embodiments, hardware circuitry may be used in combination with software instructions to implement the present invention. Thus, the techniques are not limited to any specific combination of hardware circuitry and software nor to any particular source for the instructions executed by the computer system. In addition, throughout this description, various functions and operations are described as being performed by or caused by software code to simplify description. However, those skilled in the art will recognize what is meant by such expressions is that the functions result from execution of the code by a processor.

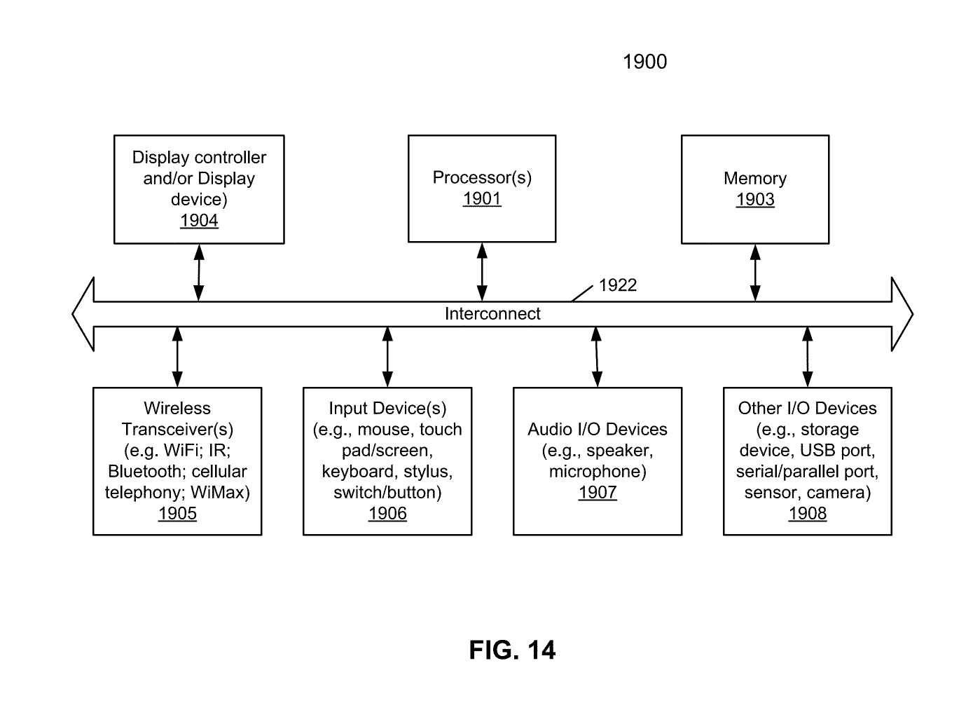

FIG. 14 is a block diagram illustrating a data processing system such as a computing system 1900 which may be used with one embodiment of the invention. For example, system 1900 may be implemented as part of an asset management system described herein. In one embodiment, system 1900 may represent either client device 101 or server 102. System 1900 may have a distributed architecture having dispersed units coupled through a network, or all of its components may be integrated into a single unit.

For example, computing system 1900 may represents any of data processing systems described above performing any of the processes or methods described above. System 1900 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 1900 is intended to show a high level view of many components of the computer system. However, it is to be understood that additional or fewer components may be present in certain implementations and furthermore, different arrangement of the components shown may occur in other implementations. System 1900 may represent a desktop, a laptop, a tablet, a server, a mobile phone, a programmable logic controller, a personal digital assistant (PDA), a personal communicator, a network router or hub, a wireless access point (AP) or repeater, a set-top box, or a combination thereof.

In one embodiment, system 1900 includes processor 1901, memory 1903, and devices 1905-1908 via a bus or an interconnect 1922. Processor 1901 may represent a single processor or multiple processors with a single processor core or multiple processor cores included therein. Processor 1901 may represent one or more general-purpose processors such as a microprocessor, a central processing unit (CPU), or the like. More particularly, processor 1901 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 1901 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 1901, which may be a low power multi-core processor socket such as an ultra low voltage processor, may act as a main processing unit and central hub for communication with the various components of the system. Such processor can be implemented as a system on chip (SoC). In one embodiment, processor 1901 may be an Intel® Architecture Core™-based processor such as an i3, i5, i19 or another such processor available from Intel Corporation, Santa Clara, Calif. However, other low power processors such as available from Advanced Micro Devices, Inc. (AMD) of Sunnyvale, Calif., an ARM-based design from ARM Holdings, Ltd. or a MIPS-based design from MIPS Technologies, Inc. of Sunnyvale, Calif., or their licensees or adopters may instead be present in other embodiments.

Processor 1901 is configured to execute instructions for performing the operations and methods discussed herein. System 1900 further includes a graphics interface that communicates with graphics subsystem 1904, which may include a display controller and/or a display device.

Processor 1901 may communicate with memory 1903, which in an embodiment can be implemented via multiple memory devices to provide for a given amount of system memory. As examples, the memory can be in accordance with a Joint Electron Devices Engineering Council (JEDEC) low power double data rate (LPDDR)-based design such as the current LPDDR2 standard according to JEDEC JESD 207-2E (published April 2007), or a next generation LPDDR standard to be referred to as LPDDR3 that will offer extensions to LPDDR2 to increase bandwidth. As examples, 2/4/8 gigabytes (GB) of system memory may be present and can be coupled to processor 1901 via one or more memory interconnects. In various implementations the individual memory devices can be of different package types such as single die package (SDP), dual die package (DDP) or quad die package (QDP). These devices can in some embodiments be directly soldered onto a motherboard to provide a lower profile solution, while in other embodiments the devices can be configured as one or more memory modules that in turn can couple to the motherboard by a given connector.

Memory 1903 can be a machine readable non-transitory storage medium such as one or more volatile storage (or memory) devices such as random access memory (RAM), dynamic RAM (DRAM), synchronous DRAM (SDRAM), static RAM (SRAM), or other types of storage devices such as hard drives and flash memory. Memory 1903 may store information including sequences of executable program instructions that are executed by processor 1901, or any other device. For example, executable code and/or data of a variety of operating systems, device drivers, firmware (e.g., input output basic system or BIOS), and/or applications can be loaded in memory 1903 and executed by processor 1901. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 1900 may further include IO devices such as devices 1905-1908, including wireless transceiver(s) 1905, input device(s) 1906, audio IO device(s) 19019, and other IO devices 1908. Wireless transceiver 1905 may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, network interfaces (e.g., Ethernet interfaces) or a combination thereof.

Input device(s) 1906 may include a mouse, a touch pad, a touch sensitive screen (which may be integrated with display device 1904), a pointer device such as a stylus, and/or a keyboard (e.g., physical keyboard or a virtual keyboard displayed as part of a touch sensitive screen). For example, input device 1906 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

Audio IO device 1907 may include a speaker and/or a microphone to facilitate voice-enabled functions, such as voice recognition, voice replication, digital recording, and/or telephony functions. Other optional devices 1908 may include a storage device (e.g., a hard drive, a flash memory device), universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. Optional devices 1908 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 1907 via a sensor hub (not shown), while other devices such as a keyboard or thermal sensor may be controlled by an embedded controller (not shown), dependent upon the specific configuration or design of system 1900.

To provide for persistent storage of information such as data, applications, one or more operating systems and so forth, a mass storage (not shown) may also couple to processor 1901. In various embodiments, to enable a thinner and lighter system design as well as to improve system responsiveness, this mass storage may be implemented via a solid state device (SSD). However in other embodiments, the mass storage may primarily be implemented using a hard disk drive (HDD) with a smaller amount of SSD storage to act as a SSD cache to enable non-volatile storage of context state and other such information during power down events so that a fast power up can occur on RE-initiation of system activities. Also a flash device may be coupled to processor 1901, e.g., via a serial peripheral interface (SPI). This flash device may provide for non-volatile storage of system software, including a basic input/output software (BIOS) as well as other firmware of the system.

Note that while system 1900 is illustrated with various components of a data processing system, it is not intended to represent any particular architecture or manner of interconnecting the components; as such details are not germane to embodiments of the present invention. It will also be appreciated that network computers, handheld computers, mobile phones, and other data processing systems which have fewer components or perhaps more components may also be used with embodiments of the invention.

Thus, various embodiments of methods, systems, and computer readable medium to manage geographically tagged serviceable assets are described herein. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

1. A system to manage serviceable assets, comprising:
an authentication subsystem, the authentication subsystem configured to determine permissions granted to a user, the user associated with a service provider;
an asset processing subsystem, the asset processing subsystem configured to:
receive serviceable asset data, the serviceable asset data including a latitude and longitude of the location where a serviceable asset is located, and
associate the serviceable asset data with service provider identification data related to the user;
an asset retrieval subsystem, the asset retrieval subsystem configured to:
receive an asset retrieval request from the user to retrieve serviceable asset data, the request including the current latitude and longitude of the user,
determine assets within a predetermined distance from the user, and
transmit serviceable asset data of the determined assets within the predetermined distance from the user;
an asset service requestor subsystem, the asset service requestor subsystem configured to:
receive a service request from a requestor to service the serviceable asset, the service request comprising identification information of the serviceable asset,
identify the service provider associated with the serviceable asset, and
generate a work order based on the service request for the service provider of the serviceable asset; and
a notification subsystem, the notification subsystem configured to:
notify the service provider about the work order, and
transmit a confirmation message to the requestor about the generated work order.

2. The system of claim 1, wherein the serviceable asset is non-movable and is at least one of a machinery or fixture, and wherein the work order relates to a request to at least clean or repair the serviceable asset.

3. The system of claim 1, wherein the serviceable asset is at least one of a heating, ventilating, and air conditioning (HVAC) equipment, cooking equipment, refrigeration equipment, or lighting equipment.

4. The system of claim 1, wherein the serviceable asset data further includes asset type information, an image, a model identifier, and a serial number associated with the serviceable asset.

5. The system of claim 1, wherein the notification subsystem notifies the service provider of the service request by at least one of an electronic mail (e-mail), a short messaging service (SMS), a notification indicator, or a pop-up window.

6. The system of claim 1 further configured to provide the user an asset service history, wherein the asset service history provides the user with total repair costs, work orders, problems, failures, and resolutions for the serviceable asset based on past service requests of the serviceable asset.

7. The system of claim 1, wherein the service request can include an image provided by the requestor, wherein the image is associated with a problem or issue related to the serviceable asset.

8. A method to manage serviceable assets, comprising:
receiving, by a computing device, a service request from a requestor to service a serviceable asset, the service request comprising identification information of the serviceable asset, wherein the computing device previously received serviceable asset data from an authorized user of the computing device, the user associated with a service provider, the serviceable asset data including a latitude and longitude of the location where the serviceable asset is located, and wherein the computing device previously associated the serviceable asset data with service provider identification data related to the user;
identifying the service provider associated with the serviceable asset;
generating a work order based on the service request for the service provider of the serviceable asset;
notifying the service provider about the work order; and
transmitting a confirmation message to the requestor about the generated work order.

9. The method of claim 8, wherein the computing device can receive an asset retrieval request from the user to retrieve serviceable asset data within a predetermined distance from the user, the request including the current latitude and longitude of the user, and wherein the computing device can determine assets within the predetermined distance from the user and transmit serviceable asset data of the assets within the predetermined distance from the user.

10. The method of claim 8, wherein the serviceable asset is non-movable and is at least one of a machinery or fixture, and wherein the work order relates to a request to at least clean or repair the serviceable asset, and wherein the serviceable asset data further includes asset type information, an image, a model identifier, and a serial number associated with the serviceable asset.

11. The method of claim 8, wherein the serviceable asset is at least one of a heating, ventilating, and air conditioning (HVAC) equipment, cooking equipment, refrigeration equipment, or lighting equipment.

12. The method of claim 8, wherein the notification subsystem notifies the service provider of the service request by at least one of an electronic mail (e-mail), a short messaging service (SMS), a notification indicator, or a pop-up window.

13. The method of claim 8, further comprising:
providing the user an asset service history, wherein the asset service history provides the user with total repair costs, work orders, problems, failures, and resolutions for the serviceable asset based on past service requests of the serviceable asset.

14. The method of claim 8, wherein the service request can include an image provided by the requestor, wherein the image is associated with a problem or issue related to the serviceable asset.

15. A non-transitory computer readable medium comprising instructions which when executed by a processing system of a computing device performs a method to manage serviceable assets, the method comprising:
receiving a service request from a requestor to service a serviceable asset, the service request comprising identification information of the serviceable asset, wherein the computing device previously received serviceable asset data from an authorized user of the computing device, the user associated with a service provider, the serviceable asset data including a latitude and longitude of the location where the serviceable asset is located, and wherein the computing device previously associated the serviceable asset data with service provider identification data related to the user;
identifying the service provider associated with the serviceable asset;
generating a work order based on the service request for the service provider of the serviceable asset;
notifying the service provider about the work order; and
transmitting a confirmation message to the requestor about the generated work order; wherein the computing device is further configured to receive an asset retrieval request from the user to retrieve serviceable asset data within a predetermined distance from the user, the request including the current latitude and longitude of the user, and wherein the computing device can determine assets within the predetermined distance from the user and transmit serviceable asset data of the assets within the predetermined distance from the user.

16. The non-transitory computer readable medium of claim 15, wherein the computing device can receive an asset retrieval request from the user to retrieve serviceable asset data within a predetermined distance from the user, the request including the current latitude and longitude of the user, and wherein the computing device can determine assets within the predetermined distance from the user and transmit serviceable asset data of the assets within the predetermined distance from the user.

17. The non-transitory computer readable medium of claim 15, wherein the serviceable asset is non-movable and is at least one of a machinery or fixture, and wherein the work order relates to a request to at least clean or repair the serviceable asset.

18. The non-transitory computer readable medium of claim 15, wherein the serviceable asset data further includes asset type information, an image, a model identifier, and a serial number associated with the serviceable asset.

19. The non-transitory computer readable medium of claim 15, wherein the notification subsystem notifies the service provider of the service request by at least one of an electronic mail (e-mail), a short messaging service (SMS), a notification indicator, or a pop-up window.

20. The non-transitory computer readable medium of claim 15, further comprising:
providing the user an asset service history, wherein the asset service history provides the user with total repair costs, work orders, problems, failures, and resolutions for the serviceable asset based on past service requests of the serviceable asset.
